(19) United States
(12) Patent Application Publication
(10) Pub. No.: US 2011/0234672 A1
(43) Pub. Date: Sep. 29, 2011

(54) INKJET IMAGE FORMING APPARATUS AND INKJET IMAGE FORMING METHOD

(75) Inventors: Kazuhiko Ohtsu, Shizuoka-ken (JP); Atsushi Kubota, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/036,362

(22) Filed: Feb. 28, 2011

Related U.S. Application Data
(60) Provisional application No. 61/316,406, filed on Mar. 23, 2010.

(51) Int. Cl. B41J 29/38

(52) U.S. Cl. 347/14

(57) ABSTRACT

According to one embodiment, an inkjet image forming apparatus includes an inkjet head which ejects an aqueous ink, a recording medium reversing mechanism for reversing a recording medium, and a controller. The controller performs control such that if a both-side recording mode is designated, the location information of an overlapping region of images to be recorded on the front surface and the rear surface is detected, based on the detected recording image location information on the front surface and the rear surface, the density of the images to be recorded at the location on the front surface and the rear surface is determined, and if the image density on one surface is higher than the image density on the other surface, the image density at the location on the one surface is reduced, and controls the inkjet head based on the control.

### CROSS-REFERENCE TO RELATED APPLICATIONS

This application is based upon and claims the benefit of U.S. Provisional Application No. 61/316,406, filed on Mar. 23, 2010; the entire contents of which are incorporated herein by reference.

### FIELD

Embodiments described herein relate generally to an inkjet image forming apparatus which forms an image on a recording medium by ejecting an aqueous ink from an inkjet head and an image forming method.

### BACKGROUND

An on-demand type inkjet image forming apparatus employs a non-impact system in which ink liquid droplets are ejected from a nozzle in response to a control signal according to a recording signal and the droplets are adhered to a recording medium. Such an inkjet image forming apparatus has a low noise, can record a high-definition image at high speed, and also is suitable for size reduction and cost reduction. Moreover, the apparatus has various advantages that it easily records a color image using multiple color inks, etc., and therefore is rapidly spreading recently.

As a method for ejecting ink liquid droplets from a nozzle, various methods are proposed. Recently, printing is increasingly performed on plain paper for PPC. When printing is performed on plain paper for PPC using an aqueous ink, paper fibers are swollen due to water in the ink and wrinkling (cockling) or curling of paper is easily caused.

On the other hand, recently, from the viewpoint of effectively utilizing a recording medium such as recording paper for energy and resource saving, recording is increasingly performed on both sides using a recording apparatus. Between when printing is performed on the front surface of paper and when printing is performed on the rear surface of the paper using an aqueous ink, cockling (paper wrinkling) or curling of paper somewhat occurs. Therefore, when printing is performed on the rear surface of paper, if paper in which cockling (paper wrinkling) or curling occurs is conveyed as such, a difference in height occurs on the recording surface of the paper, resulting in deteriorating an image.

### BRIEF DESCRIPTION OF THE DRAWINGS

FIG. 1 is a view showing an exemplary schematic structure of an inkjet image forming apparatus according to a first embodiment.

FIG. 2 is a view showing an exemplary schematic structure of a recording medium drying unit according to the first embodiment.

FIG. 3 is an exemplary block diagram showing a structure of a control system of an inkjet image forming apparatus according to the first embodiment.

FIG. 4 is a view of an exemplary ink penetration model showing a bleeding manner when an ink ejected from an inkjet head is adhered and penetrates into a recording medium in the case of both-side printing.

FIG. 5 is a view showing an exemplary ink penetration model when using an inkjet image forming apparatus according to the first embodiment.

FIG. 6 is a flowchart showing an exemplary image forming procedure in an inkjet image forming apparatus according to the first embodiment.

FIG. 7 is a view for explaining an exemplary relationship between the range of the total amount of an ink and the amount of an applied energy for drying in an inkjet image forming apparatus according to the first embodiment.

FIG. 8 is a flowchart showing an exemplary calculation procedure for an applied energy for drying in an inkjet image forming apparatus according to the first embodiment.

FIG. 9 is a view showing an exemplary schematic structure of an inkjet image forming apparatus according to a second embodiment.

### DETAILED DESCRIPTION

In general, according to one embodiment, an inkjet image forming apparatus includes an inkjet head which ejects an aqueous ink, a recording medium reversing mechanism for reversing a recording medium, and a controller. The controller performs control such that if a both-side recording mode is designated, the location information of an overlapping region of images to be recorded on the front surface and the rear surface is detected, based on the detected recording image location information on the front surface and the rear surface, the density of the images to be recorded at the location on the front surface and the rear surface is determined, and if the image density on one surface is higher than the image density on the other surface, the image density at the location on the one surface is reduced, and controls the inkjet head based on the control.

### First Embodiment

In a first embodiment, an inkjet image forming apparatus provided with four color inkjet heads will be described.

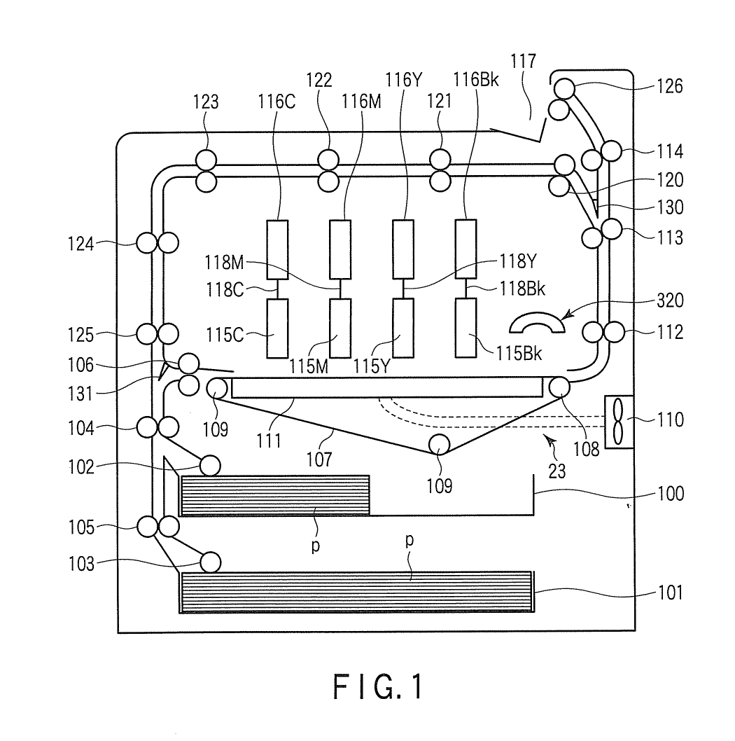

FIG. 1 is a view showing an exemplary schematic structure of an inkjet image forming apparatus according to this embodiment.

Paper cassettes 100 and 101 contain paper p having different sizes, respectively. A paper feeding roller 102 or 103 takes up the paper p having a size corresponding to the selected paper size from the paper cassette 100 or 101 and conveys the paper p to a conveying roller pair 104 or 105 and a resist roller pair 106. Incidentally, the paper p is not exclusive paper but plain paper.

A conveying belt 107 is tensioned by a driving roller 108 and two driven rollers 109. The conveying belt 107 has on the surface thereof a lot of small diameter through-holes at given intervals. The conveying belt 107 is an endless belt formed by laminating rubber to fibers and polishing the surface, and small diameter holes (not shown) are formed on the entire surface thereof. The conveying belt 107 may be formed by processing the end portions of a belt with ends made of stainless steel or the like.

A negative pressure chamber 111 is provided such that a top plate thereof is in close contact with the rear surface of the conveying belt 107 on the side in contact with the driving roller 108. The negative pressure chamber 111 is connected to a fan 110 via a duct 23. The negative pressure chamber 111 is a box-shaped housing provided with an upper top plate having a lot of grooves and holes and a hole for connection to the duct 23 for discharging air. The hollow internal space of the housing is set to negative pressure by suction with the fan 110.

Due to a suction force generated by the suction fan 110, the paper p is adsorbed to the conveying surface of the conveying belt 107 through the duct 23, the negative pressure chamber 111, and a lot of small diameter holes on the conveying belt 107. The paper p is conveyed while being adsorbed to the conveying belt 107.

On the upper side of the conveying belt 107, four line-type inkjet heads 115 each of which ejects an ink onto paper according to image data are arranged side by side, and from the upstream side (from the left side in the drawing), an inkjet head 115C which ejects a cyan (C) ink, an inkjet head 115M which ejects a magenta (M) ink, an inkjet head 115Y which ejects a yellow (Y) ink, and an inkjet head 115Bk which ejects a black (Bk) ink are disposed in this order. Further, the respective inkjet heads 115 are provided with a cyan (C) ink cartridge 116C, a magenta (M) ink cartridge 116M, a yellow (Y) ink cartridge 116Y, and a black (Bk) ink cartridge 116Bk, each of which contains an ink of each color. The inkjet heads 115 and ink cartridges 116 are connected to each other through tubes 118, respectively.

Each inkjet head 115 has nozzles with a given pitch on the end surface of the main body thereof. Further, printing is performed using the inkjet heads 115 by any known method.

On the paper discharging side (on the right side in the drawing), conveying roller pairs 112, 113, and 114, and a paper discharging roller pair 126 are provided. The paper p is discharged to a paper discharge tray 117 by the paper discharging roller pair 126.

A conveying guide 130 and conveying roller pairs 120, 121, 122, 123, 124, and 125 for sending the paper p again to the paper feeding side (to the left side in the drawing) in the case of performing both-side printing, and a conveying guide 131 for switching the path of the paper p for printing on the rear surface are provided. The conveying guides 130 and 131 are configured such that the direction of the tip of the guide is changed using the fulcrum as the center. The conveying guide 130 switches the conveying route of the paper p between the route on the paper discharging side and the route on the paper feeding side. The conveying guide 131 switches the path between the path for reversing the paper p and the path for conveying for printing on the rear surface. The conveying roller pairs 120, 121, 122, 123, 124, and 125 constitute a part of the reversing mechanism and the reversing mechanism is located on the upper side of the respective inkjet heads 115 and in the direction orthogonal to the upper side.

On the side of the subsequent stage to the conveying belt 107 in the paper conveying direction, that is, on the downstream side of the inkjet heads 115 in the conveying direction, a recording medium drying unit 320 which dries the paper p having an image formed thereon is provided. As the recording medium drying unit 320, a hot air heater, a ceramic heater, a rubber heater, a halogen heater, or the like is used. The recording medium drying unit 320 is heated such that the surface temperature of the conveyed paper p is 30° C. or higher, preferably in the range from 40° C. to 80° C.

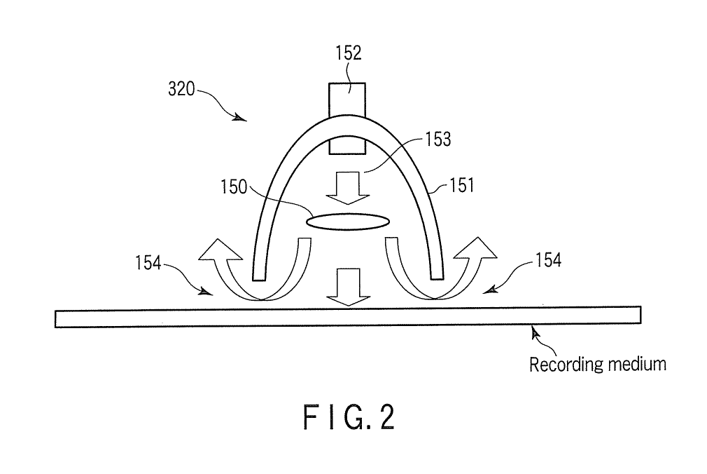

FIG. 2 is a view showing an exemplary schematic structure of the recording medium drying unit according to this embodiment. The recording medium drying unit 320 is provided with a halogen heater 150, a hood 151, and an air suction duct 152. Air 153 sucked from the air suction duct 152 is heated by the halogen heater 150. Heated air 154 is blown to the surface of the conveyed recording medium, thereby drying the ink adhered to the surface of the recording medium. It is not necessary that the recording medium drying unit 320 completely dry the ink on the recording medium. The drying may be performed to such an extent that an adverse effect of cockling or the like is not brought about in the subsequent process.

In general, as a method for performing gradation printing using an inkjet printer, various methods such as an area coverage modulation method, a density modulation method, and a multi-drop driving method can be used. In this embodiment, a multi-drop driving method is used.

Incidentally, as the inks of the respective colors, aqueous inks which are black (Bk), yellow (Y), cyan (C), and magenta (M), and contain water in an amount of from about 30 to 80% by weight in the composition other than the solid content and additives are used.

Subsequently, a both-side recording action and a one-side recording action of the inkjet image forming apparatus according to this embodiment will be described in detail.

The image data for recording is transferred to the respective inkjet heads 115C, 115M, 115Y, and 115Bk shown in FIG. 1. Further, the paper feeding roller 102 or 103 takes up the paper p one by one from the paper cassette 100 or 101 and conveys the paper p to the conveying roller pair 104 or 105 and the resist roller pair 106. At this time, the conveying guide 131 is directed in a given direction such that the paper p is conveyed through a given conveying path. The resist roller pair 106 corrects the skew of the paper p and conveys the paper p at a given timing.

Since the negative pressure chamber 111 sucks air through a lot of small diameter holes of the conveying belt 107 by the fan 110, the paper p is conveyed on the lower side of the inkjet heads 115 in a state where the paper p is adsorbed to the conveying belt 107. In this manner, a constant distance can be maintained between the inkjet heads 115 and the paper p.

In synchronous with the timing that the paper p is conveyed from the resist roller pair 106, the inks of the respective colors are ejected from the inkjet heads 115C, 115M, 115Y, and 115Bk, respectively, based on the image data, whereby a color image is formed on the front surface of the paper p. The paper p having the image formed on the front surface thereof is dried by the recording medium drying unit 320 with an adequate output power (described later).

In the case of both-side recording, the paper p is returned once to the paper feeding position around the paper cassette 100 or 101 by the conveying roller pairs 112, 113, 120, 121, 122, 123, 124, 125, 104, and 105. Then, the paper p is reversed by a switch-back action with the conveying roller pair 104 or 105 and the resist roller pair 106 and conveyed to the printing position again. At this time, the conveying guides 130 and 131 are directed in a given direction such that the paper p is conveyed through a given conveying path. The resist roller pair 106 corrects the skew of the reversed paper p and conveys the paper p at a given timing.

Since the negative pressure chamber 111 sucks air through a lot of small diameter holes of the conveying belt 107 by the fan 110, the paper p is conveyed on the lower side of the inkjet heads 115 in a state where the paper p is adsorbed to the conveying belt 107. In synchronous with the timing that the paper p is conveyed from the resist roller pair 106, the inks of the respective colors are ejected from the inkjet heads 115C, 115M, 115Y, and 115Bk, respectively, whereby a color image is formed at a desired location on the rear surface of the paper p.

The paper p having the images formed on the front surface and the rear surface thereof is again allowed to pass through the recording medium drying unit 320 and dried, and thereafter conveyed by the conveying roller pairs 112, 113, and 114, and discharged to the paper discharge tray 117 by the paper discharging roller pair 126. At this time, the conveying guide 130 is directed in a given direction such that the paper p is conveyed through a given conveying path.

In the case of both-side recording and face-down paper discharge, the rear surface is the first page surface and the front surface is the second page surface, and in the case of face-up paper discharge, the front surface is the first page surface and the rear surface is the second page surface.

When one-side recording is performed, after an image is formed on the front surface of the paper p at the first recording (recording on the front surface), the paper p is allowed to pass through the recording medium drying unit 320, and the ink is dried with an adequate output power (described later), and thereafter the paper p is conveyed by the conveying roller pairs 112, 113, and 114, and discharged to the paper discharge tray 117 by the paper discharging roller pair 126 in a face-down manner (in a state where the recording surface faces down). At this time, the conveying guide 130 is directed in a given direction such that the paper p is conveyed through a given conveying path. In the case of one-side recording and face-down paper discharge, the front surface is the first page surface.

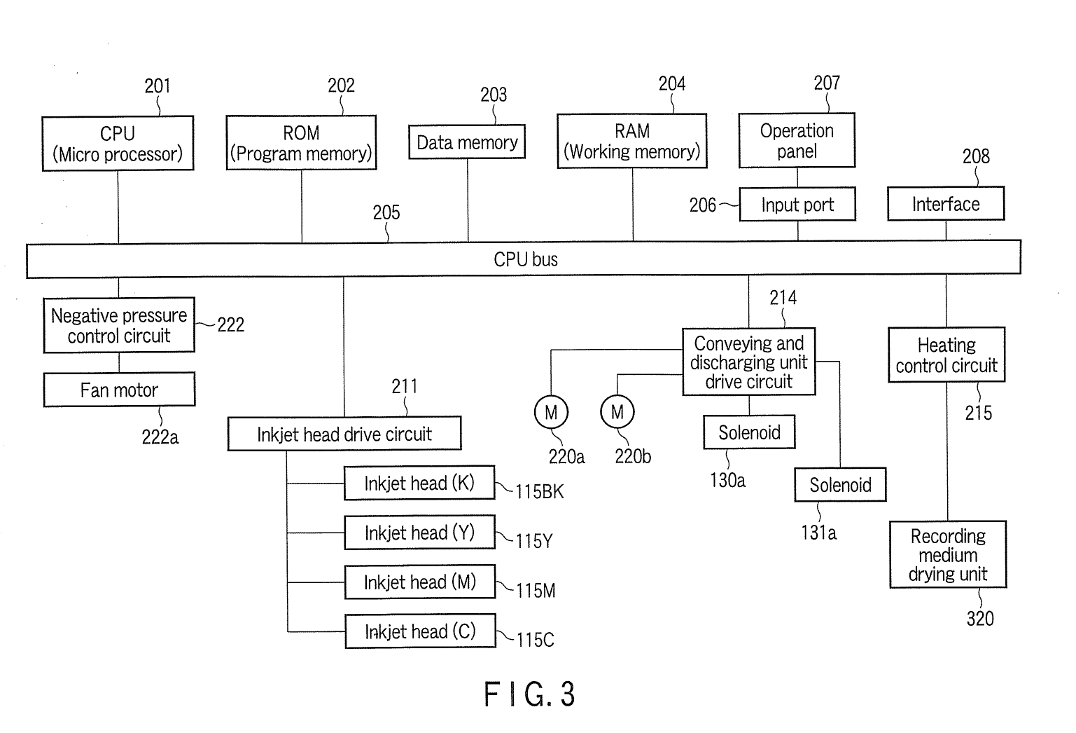

FIG. 3 is an exemplary block diagram showing a structure of a control system of the inkjet image forming apparatus according to this embodiment.

The control system of the inkjet image forming apparatus includes a CPU (central processing unit) 201 serving as a processor, a ROM (read only memory) 202, a data memory 203, a RAM (random-access memory) 204, a CPU bus 205, an input port 206, an interface 208, an inkjet head drive circuit 211, a conveying and discharging unit drive circuit 214, a heating control circuit 215, and the like. The processor also functions as a controller.

The CPU 201 collectively controls the respective units of the inkjet image forming apparatus. The ROM 202 and the RAM 204 are connected to the CPU 201 via the CPU bus 205 to form a microcomputer. The ROM 202 stores an action program to perform drive control. The data memory 203 stores data. The input port 206 transfers information from and to an operation panel 207. The interface 208 transfers information from and to an external computer.

The inkjet head drive circuit 211 drives and operates the respective inkjet heads 115. The conveying and discharging unit drive circuit 214 drives respective motors 220a, 220b, etc. connected to the conveying roller pairs 104 and 105, the driving roller 108, the conveying roller pairs 112, 113, and 114, the paper discharging roller pair 126, and the like, and solenoids 130a and 131a connected to the conveying guides 130 and 131. A negative pressure control circuit 222 controls an operating voltage for a fan motor 222a of the fan 110. The heating control circuit 215 controls the action of the recording medium drying unit 320.

Subsequently, the action of the control system will be described. The respective units of the inkjet image forming apparatus are basically controlled by the CPU 201. The respective units are controlled according to the action program stored in the ROM 202.

First, the image data or printing command sent from the external computer via the interface 208 is transferred to the RAM 204 and processed by the CPU 201 based on the action program stored in the ROM 202, stored command data or the like. The processed printing data is sent to the inkjet head drive circuit 211 and a driving signal for printing is sent to each inkjet head 115.

On the other hand, the CPU 201 receives information as to whether a both-side recording mode or a one-side recording mode is performed from the external interface 208. Then, the CPU 201 selects a recording density stored in the data memory 203 and outputs the information to the inkjet head drive circuit 211.

The inkjet head drive circuit 211 operates according to the image data or the like and controls the ejection of the inks from the inkjet heads 115 in synchronous with the timing that the paper p is conveyed. The respective inkjet heads 115 eject the inks from the nozzles according to the driving signals as multi-drop ink droplets onto the paper p.

The CPU 201 gives an instruction to the conveying and discharging unit drive circuit 214 such that the paper p is conveyed in synchronous with the movement of the respective inkjet heads 115. Further, the CPU 201 also gives an instruction to the conveying and discharging unit drive circuit 214 so as to change the conveying path according to the one-side recording mode or the both-side recording mode and controls the conveying guides 130 and 131.

Further, the CPU 201 receives the information as to whether a both-side recording mode or a one-side recording mode is performed from the external interface 208 and selects a necessary output power condition stored in the data memory 203 based on the information. The CPU 201 selects an energy to be used by the recording medium drying unit 320 based on the output power condition when printing is performed on the front surface or the rear surface. Further, the CPU 201 controls the power supply required for generating an energy for drying for the recording medium drying unit 320.

Subsequently, an image forming method in the case of both-side recording using the inkjet image forming apparatus according to this embodiment will be described.

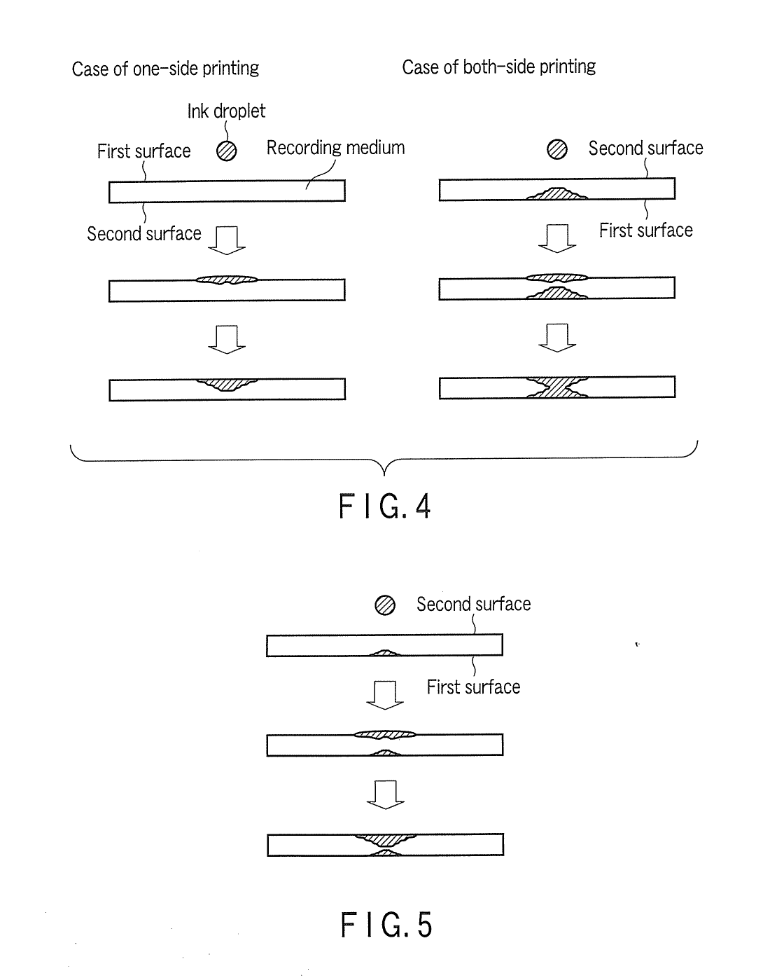

FIG. 4 is a view of an exemplary ink penetration model showing a bleeding manner when the ink ejected from the inkjet head is adhered and penetrates into a recording medium in the case of both-side printing. Hereinafter, in the case of both-side printing, the surface of a recording medium printed first is referred to as a first surface and the surface of the recording medium printed subsequently is referred to as a second surface.

When an ink droplet ejected onto the first surface of a recording medium adheres to the surface of the recording medium, the ink droplet diffuses and penetrates in the thickness direction of the recording medium and is fixed thereto. When both-side recording is performed, thereafter, an ink droplet is ejected onto the second surface of the recording medium and diffuses and penetrates in the thickness direction of the recording medium and is fixed thereto in the same manner as described above. At this time, the ink already penetrating into the first surface of the recording medium and the ink newly penetrating are mixed with each other in the inside of the recording medium in some cases, resulting in deteriorating the recording quality.

FIG. 5 is a view showing an exemplary ink penetration model when using the inkjet image forming apparatus according to this embodiment.

In this embodiment, the amount of the ink droplet ejected onto the first surface of the recording medium is changed and reduced to an amount less than a given amount. The amount of the ink droplet ejected onto the second surface of the recording medium is a given amount. As a result, it is possible to avoid mixing the inks adhered to the first surface and second surface, respectively, of the recording medium in the inside of the recording medium.

Further, by reducing the amount of the ink to be adhered to the first surface of the recording medium according to this embodiment, the effect such as cockling can be reduced. As a result, the correction by the suction adhesion force to the conveying belt 107 can be effectively achieved when printing is performed on the second surface of the recording medium. Accordingly, unevenness of an image, color shift, or the like caused by landing position shift of ink droplets is reduced, and therefore, a color image can be formed with high accuracy at a desired location of the recording medium, and the recording quality can be improved.

Incidentally, a region where the amount of the ink droplet is reduced on the first surface of the recording medium is a region where the ink droplet is adhered to the second surface of the recording medium. That is, when there is a region where the ink droplet is not adhered on the second surface of the recording medium, the amount of the ink droplet in the corresponding region of the first surface of the recording medium is not changed.

Incidentally, the determination as to whether or not the amount of the ink droplet on the first surface of the recording medium is reduced is related to the penetration depth of the ink. That is, the determination as to whether or not the amount of the ink on the first surface of the recording medium is reduced is made according to the penetration depth of the ink on the second surface of the recording medium. Therefore, the determination as to whether or not the amount of the ink on the first surface of the recording medium is reduced can be made according to the amount of the ink droplet in other words, the image density on the second surface of the recording medium. The penetration depth of the ink is also affected by the type of the recording medium or the ink, and therefore, the threshold for the determination may be set according to the type of the recording medium or the ink.

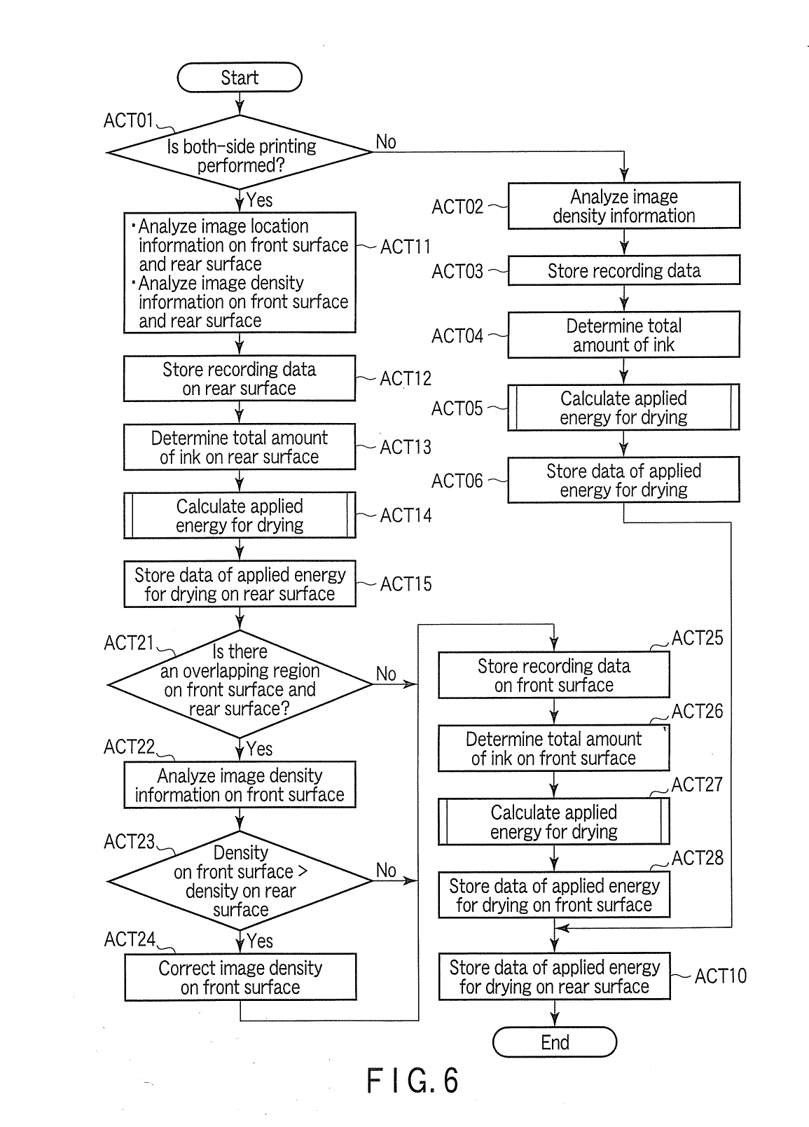

FIG. 6 is a flowchart showing an exemplary image forming procedure in the inkjet image forming apparatus according to this embodiment.

In Act 01, the CPU 201 determines as to whether the recording information is both-side recording or one-side recording.

When the recording information is one-side recording (No in Act 01), in Act 02, the CPU 201, analyzes the image density information and the like from the recording information. In Act 03, the analyzed data is stored in the RAM 204. Incidentally, the recording information is, for example, received from an external computer 209 via the interface 208 and stored in the RAM 204. In Act 04, the total amount of the ink per sheet of paper is analyzed from the recording information. In Act 05, an applied energy for drying is calculated. In the calculation of an applied energy for drying, the amount of an applied energy (applied voltage or applied current) for drying to be applied by the recording medium drying unit 320 is determined according to the range of the total amount of the ink. The detailed calculation of the applied energy for drying will be described later.

In Act 06, the CPU 201 stores the data of the calculated applied energy for drying is stored in the RAM 204. In Act 10, the CPU 201 gives an instruction for the applied energy for drying to the heating control circuit 215 and causes it to control the heating for the recording medium.

Subsequently, a processing procedure when the recording information is both-side recording will be described.

When the recording information is both-side recording (Yes in Act 01), in Act 11, the CPU 201 analyzes the image location information and the image density information on the front surface and the rear surface of the recording medium from the recording information. Then, in Act 12, the image location information and the image density information on the rear surface (second surface) are stored in the RAM 204 as the recording data on the rear surface. In Act 13, the total amount of the ink on the rear surface (second surface) is analyzed from the recording information. In Act 14, an applied energy for drying is calculated. This calculation is the same as that in Act 05 described above, and a detailed description will be made later. In Act 15, the CPU 201 stores the data of the calculated applied energy for drying on the rear surface in the RAM 204.

In Act 21, the CPU 201 detects the location of the image data on the front surface and the rear surface from the image location information and determines whether the images overlap with each other at each location. When it is determined that the images do not overlap with each other (No in Act 21), in Act 25, the image data on the front surface (first surface) is stored in the RAM 204 without correcting the image data.

When it is determined that the images overlap with each other (Yes in Act 21), in Act 22, the degree of the image density on the front surface and the rear surface at each location in the region where the images overlap with each other is determined. When it is determined that the image density on the front surface is lower than the image density on the rear surface (No in Act 23), in Act 25, the image data on the front surface (first surface) is stored in the RAM 204 without correcting the image data.

When it is determined that the image density on the front surface (first surface) is higher than the image density on the rear surface (Yes in Act 23), the image density on the front surface (first surface) is corrected. Then, in Act 25, the image data on the front surface (first surface) is stored in the RAM 204.

In the correction of the image density, the following various methods can be used alone or by combining them appropriately.

(1) The image density on the front surface (first surface) is reduced by a given amount x. The given amount x to be reduced is determined according to the type of the recording medium, the type of the ink, the environmental conditions, etc.

(2) The image density on the front surface (first surface) is reduced to a value not higher than the image density on the rear surface (second surface). The amount to be reduced is determined according to the type of the recording medium, the type of the ink, the environmental conditions, etc.

(3) When the image density on the rear surface (second surface) is higher than a given value y, the image density on the front surface (first surface) is reduced by a given amount z. When the image density on the rear surface (second surface) is a given value y or lower, the image density on the front surface (first surface) is changed to a value equal to the image density on the rear surface (second surface). For example, when it is estimated that the penetration depth of the ink on the rear surface is not more than half the thickness of the recording medium, the image density on the front surface is made equal to the image density on the rear surface.

(4) When the image density on the front surface (first surface) is higher than a given value w, the image density on the front surface (first surface) is changed to a value equal to the image density on the rear surface (second surface). When the image density on the front surface (first surface) is a given value w or lower, the image density on the front surface (first surface) is not changed. For example, when it is estimated that the penetration depth of the ink on the front surface is not more than half the thickness of the recording medium, the image density on the front surface is not changed.

In Act 26, the total amount of the ink on the front surface (first surface) is analyzed from the recording information. In Act 27, an applied energy for drying is calculated. This calculation is the same as that in Act 05 described above, and a detailed description will be made later. In Act 28, the CPU 201 stores the data of the calculated applied energy for drying on the front surface in the RAM 204.

In Act 10, the CPU 201 gives an instruction for the applied energy for drying to the heating control circuit 215 and causes it to control the heating for the recording medium.

Subsequently, the CPU 201 controls the inkjet heads based on the image data obtained by correcting the image density stored in the RAM 204 in Act 25 and causes the inkjet heads to eject the ink. That is, the CPU 201 controls the inkjet heads based on the reduced image density.

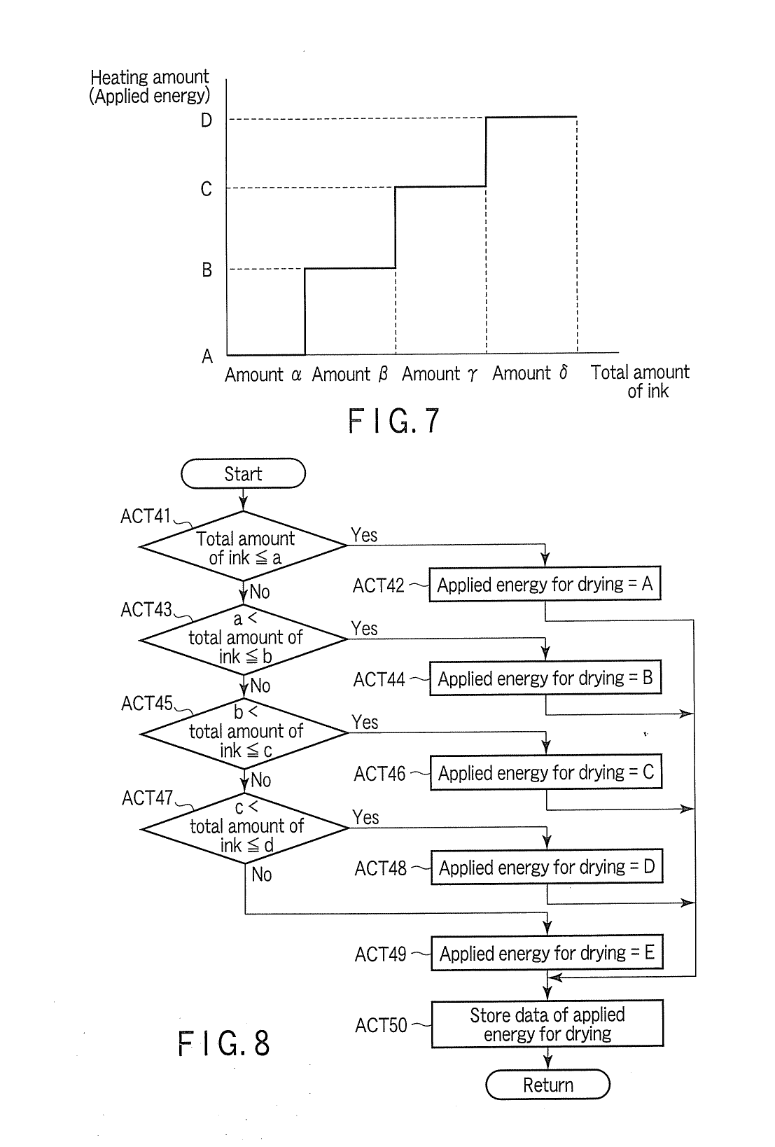

FIG. 7 is a view for explaining an exemplary relationship between the range of the total amount of the ink and the amount of the applied energy for drying in the inkjet image forming apparatus according to this embodiment.

When the total amount of the ink ejected from the inkjet heads 115 is in the range of α, the energy amount to be applied to the heating section 220 is A (no energy is applied). In the same manner, when the total amount of the ink ejected from the inkjet heads 115 is in the ranges of β, γ, and δ, the energy amount to be applied to the heating section 220 is B, C, and D, respectively. In FIG. 7, the case where the control is performed by dividing the total amount of the ink and the energy amount into four stages, respectively, is described, however, it is not limited thereto, and the control may be performed by dividing the total amount of the ink and the energy amount into five stages, respectively, or six stages, respectively as needed.

FIG. 8 is a flowchart showing an exemplary calculation procedure for the applied energy for drying in the inkjet image forming apparatus according to this embodiment.

When the total amount of the ink is a or less (Yes in Act 41), in Act 42, the applied energy for drying is determined to be A. When the total amount of the ink exceeds a and is not more than b (Yes in Act 43), in Act 44, the applied energy for drying is determined to be B. When the total amount of the ink exceeds b and is not more than c (Yes in Act 45), in Act 46, the applied energy for drying is determined to be C. When the total amount of the ink exceeds c and is not more than d (Yes in Act 47), in Act 48, the applied energy for drying is determined to be D. When the total amount of the ink exceeds d (No in Act 47), in Act 49, the applied energy for drying is determined to be E. Then, the process is returned to Act 06 in FIG. 6.

Incidentally, the above-mentioned respective parameters a, b, c, d, A, B, C, D, and E are determined in advance according to the type of the recording medium, the type of the ink, the environmental conditions, etc. The respective parameters are stored in the data memory 203.

When the recording method using the inkjet heads 115C, 115M, 115Y, and 115Bk in this embodiment is a multi-drop method, the correction can also be performed by reducing the number of ink droplets to be recorded. Incidentally, the correction by reduction of the recording image density may be performed such that in order to reduce the recording image density, the recording data is reduced so as to reduce the size of the liquid droplet of the ink ejected from the inkjet heads 115C, 115M, 115Y, and 115Bk (volume control). Further, in an overlapping region of a large image on the front surface and the rear surface, the correction can also be achieved by performing thinning processing. In the thinning processing, the correction can be achieved by thinning the image data such that the printing information is reduced to, for example, 50%.

Further, in the above embodiment, the recording medium drying unit 320 heats all the surfaces of the printed recording medium, however, it may heat only the front surface (first surface) in a both-printing mode. That is, the image forming apparatus may be configured such that the recording medium drying unit 320 is used only for preventing the deterioration of the image when printing is performed on the rear surface.

### Second Embodiment

In a second embodiment, the structure of the inkjet image forming apparatus is different from that in the first embodiment, however, the structure and action of the control system shown in FIG. 3 are the same as those in the first embodiment. The same reference numerals are provided for the same units as those in the first embodiment and a detailed description thereof is omitted.

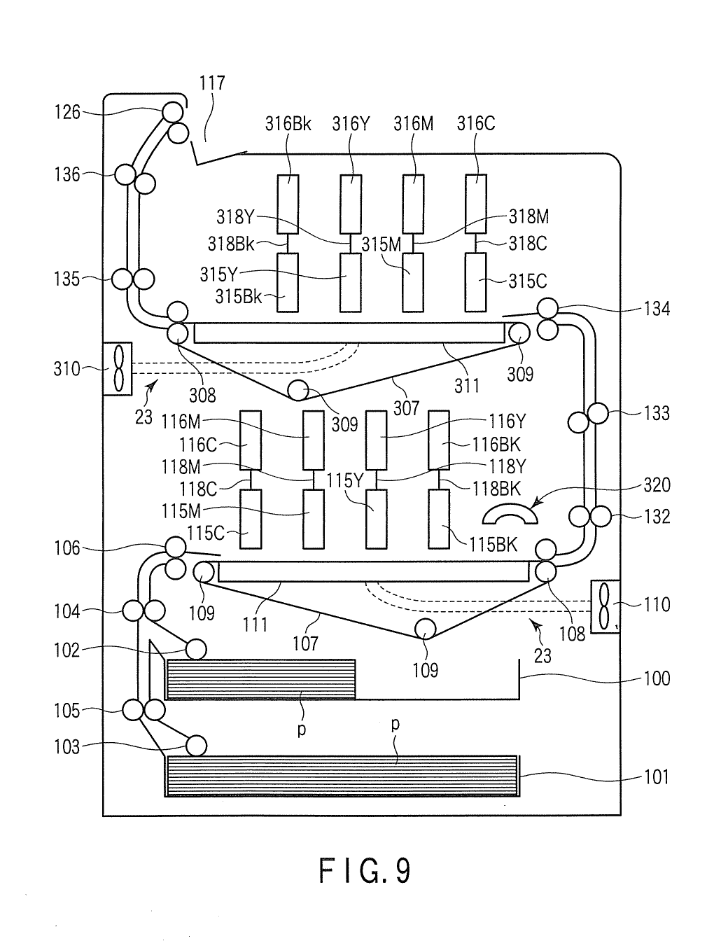

FIG. 9 is a view showing an exemplary schematic structure of the inkjet image forming apparatus according to a second embodiment.

Paper cassettes 100 and 101, paper feeding rollers 102 and 103, conveying roller pairs 104 and 105, a resist roller pair 106, a conveying belt 107, a driving roller 108, two driven rollers 109, a fan 110, and a negative pressure chamber 111 are the same as those in the first embodiment, and therefore, a description thereof is omitted.

The respective inkjet heads 115 and the respective ink cartridges 116 are the same as those in the first embodiment except that they are provided as an image forming unit for exclusive use in recording on the front surface of the paper p, and therefore, a description thereof is omitted. The same shall apply to tubes 118.

On the upper side of the respective inkjet heads 115 and the respective ink cartridges 116, in other words, on the downstream side of the respective inkjet heads in the conveying direction, an image forming unit for exclusive use in recording on the rear surface of the paper p having the same structure as that of the image forming unit for exclusive use in recording on the front surface of the paper p is provided. Further, conveying roller pairs 132 and 133, and a resist roller pair 134 for conveying the paper p to the image forming unit for exclusive use in recording on the rear surface of the paper p are provided. The conveying roller pairs 132 and 133, and the resist roller pair 134 constitute a part of a reversing mechanism, and the reversing mechanism is formed into a U shape.

A conveying belt 307 is tensioned by a driving roller 308 and two driven rollers 309. The conveying belt 307 has on the surface thereof a lot of small diameter holes at given intervals. In order to adsorb the paper p to the conveying belt 307, a negative pressure chamber 311 connected to a fan 310 via a duct 23 is provided in the inside of the conveying belt 307 such that a top plate of the negative pressure chamber 311 is in close contact with the rear surface of the conveying belt 307.

On the upper side of the conveying belt 307 (four inkjet heads for exclusive use in printing on the rear surface, each of which ejects an ink onto paper according to image data, are arranged side by side, and from the upstream side, an inkjet head 315C which ejects a cyan (C) ink, an inkjet head 315M which ejects a magenta (M) ink, an inkjet head 315Y which ejects a yellow (Y) ink, and an inkjet head 315Bk which ejects a black (Bk) ink are disposed in this order. Further, respective inkjet heads 315 are provided with a cyan (C) ink cartridge 316C, a magenta (M) ink cartridge 316M, a yellow (Y) ink cartridge 316Y, and a black (Bk) ink cartridge 316Bk, each of which contains an ink of each color and are connected thereto through tubes 318, respectively. These image forming sections are provided as the image forming unit for exclusive use in printing on the rear surface of the paper p.

Further, on the paper discharging side, conveying roller pairs 135 and 136, and a paper discharging roller pair 126 are provided. In the case of both-side recording and face-down paper discharge, the rear surface is the first page surface and the front surface is the second page surface, and in the case of face-up paper discharge, the front surface is the first page surface and the rear surface is the second page surface.

As the inks of the respective colors, aqueous inks which are black (Bk), yellow (Y), cyan (C), and magenta (M), and contain water in an amount of from about 30 to 80% by weight in the composition other than the solid content and additives are used in the same manner as in the first embodiment.

Subsequently, an action of image formation by both-side recording of the inkjet image forming apparatus according to the second embodiment will be described.

As described with reference to the flowchart of FIG. 6, first the determination is made as to whether both-side recording or one-side recording is performed.

In the case of both-side recording, the recording information and the attribute information thereof are analyzed. From the attribute information, the image data location information on the front surface and the rear surface is detected and it is determined whether or not the images overlap with each other. When it is determined that the images do not overlap with each, the image data is temporarily stored. When it is determined that the images overlap with each other, further it is determined whether or not correction of the density is needed based on the image density in the overlapping region on the front surface and the rear surface. From the determination results, the image density is corrected, and the corrected image data is temporarily stored.

Thereafter, the image data on the front surface for recording is transferred to the respective inkjet heads 115C, 115M, 115Y, and 115Bk. Further, the paper feeding roller 102 or 103 takes up the paper p having a size corresponding to the selected paper size one by one from the paper cassette 100 or 101 and conveys the paper p to the conveying roller pair 104 or 105 and the resist roller pair 106. The resist roller pair 106 corrects the skew of the paper p and conveys the paper p at a given timing.

Since the negative pressure chamber 111 sucks air through a lot of small diameter holes of the conveying belt 107 by the fan 110, the paper p is conveyed on the lower side of the inkjet heads 115 in a state where the paper p is adsorbed to the conveying belt 107. In this manner, a constant distance can be maintained between the inkjet heads 115 and the paper p. In synchronous with the timing that the paper p is conveyed from the resist roller pair 106, the inks of the respective colors are ejected from the inkjet heads 115C, 115M, 115Y, and 115Bk, respectively, whereby a color image is formed at a desired location on the front surface of the paper p.

The paper p having the image formed on the front surface thereof is dried to some extent by the recording medium drying unit 320, and thereafter the paper p is conveyed to the image forming unit for exclusive use in printing on the rear surface by the conveying roller pairs 132 and 133, and the resist roller pair 134. The resist roller pair 134 corrects the skew of the paper p again and conveys the paper p at a given timing to the image forming unit for exclusive use in printing on the rear surface.

Since the negative pressure chamber 311 sucks air through a lot of small diameter holes of the conveying belt 307 by the fan 310, the paper p is conveyed on the lower side of the inkjet heads 315 in a state where the paper p is adsorbed to the conveying belt 307. At this time, in the same manner as in the first embodiment, the image density (the adhesion amount of the ink) is reduced based on the corrected recording image data in the first recording (recording on the front surface). Therefore, cockling (paper wrinkling) or curling of paper occurring on the front surface of the paper p is also reduced. Further, the paper p is corrected by the suction adhesion force to the conveying belt, and therefore, a constant distance can be maintained between the inkjet heads 315 and the paper p.

Thereafter, in synchronous with the timing that the paper p is conveyed from the resist roller pair 134, the inks of the respective colors are ejected from the inkjet heads 315C, 315M, 315Y, and 315Bk, respectively, whereby a color image is formed at a desired location on the rear surface of the paper p. The paper p having the images formed on the front surface and the rear surface thereof is conveyed by the conveying roller pairs 135 and 136, and discharged to the paper discharge tray 117 by the paper discharging roller pair 126. In the case of both-side recording and face-down paper discharge, the rear surface is the first page surface and the front surface is the second page surface, and in the case of face-up paper discharge, the front surface is the first page surface and the rear surface is the second page surface.

Further, when only one-side recording is performed, the paper p is allowed to pass through the image forming unit for exclusive use in recording on the front surface in the case of both-side recording, and recording is performed only on the rear surface of the paper p by the image forming unit for exclusive use in recording on the rear surface, and thereafter, the paper p is conveyed by the conveying roller pairs 135 and 136, and discharged to the paper discharge tray 117 by the paper discharging roller pair 126 in a face-down manner (in a state where the recording surface faces down).

The structure and action of the inkjet image forming apparatus described in the first and second embodiments are not limited to those described above. Further, the conveying belt may be a strip-shaped endless belt type or a cylindrical drum type. Further, a system for bringing the recording medium into close contact with the conveying belt in the image formation may be an air suction type using a negative pressure fan or an electrostatic adsorption type using an electrostatic force.

According to the first and second embodiments described above, various effects can be obtained.

In the first recording (recording on the front surface), the image density (the adhesion amount of the ink) is reduced based on the corrected recording image data, and therefore, cockling (paper wrinkling) or curling of paper occurring on the front surface of the paper p is also reduced.

Further, the paper p is corrected by the suction adhesion force to the conveying belt, and therefore, a constant distance can be maintained between the inkjet heads 115 and the paper p. Accordingly, an image can be formed at a desired location on the rear surface of the paper p.

Further, the ink liquid droplet adhered to the rear surface of the paper p does not mix in the inside of the paper p as shown in the ink penetration model of FIG. 5.

As described above, by using the inkjet image forming apparatus according to the first and second embodiments, a recording medium in which cockling (paper wrinkling) or curling caused by performing recording on the front surface of the recording medium is reduced to such an extent that it does not affect the recording on the rear surface can be conveyed, and images recorded on both sides with high printing quality can be obtained.

Further, by controlling the output power of the heating section of the recording medium drying unit 320 according to the total amount of the ink on the recording medium, an energy required for drying the ink can be efficiently consumed, and therefore, power consumption can be suppressed.

In the first and second embodiments, the case where data is received from the external computer and printing is performed is described, however, the above effects may be achieved by an apparatus in which a scanner structure is added to the inkjet image forming apparatus so that copying can be performed in the inside of the inkjet image forming apparatus.

Incidentally, the respective functions described in the above embodiments may be constituted using hardware, and also may be realized by causing a computer to read a program in which the respective functions are written using software. Further, the respective functions may be constituted by appropriately selecting either software or hardware.

Further, the respective functions can also be realized by causing a computer to read a program stored in a recording medium (not shown). Here, in the recording medium according to this embodiment, any recording form may be used as long as the recording medium can record the program, and can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet image forming apparatus comprising:
an inkjet head which ejects an aqueous ink;
a recording medium reversing mechanism for reversing a recording medium; and
a controller which performs control such that if a both-side recording mode is designated, the location information of an overlapping region of images to be recorded on the front surface and the rear surface is detected, based on the detected recording image location information on the front surface and the rear surface, the density of the images to be recorded at the location on the front surface and the rear surface is determined, and if the image density on one surface is higher than the image density on the other surface, the image density at the location on the one surface is reduced, and controls the inkjet head based on the control.

2. The apparatus according to claim 1, wherein the apparatus further comprises a recording medium drying unit which dries the recording medium having an image formed thereon.

3. The apparatus according to claim 2, wherein the controller gives an instruction to the recording medium drying unit to dry only the surface on which printing is first performed using the inkjet head as to either the one surface or the other surface.

4. The apparatus according to claim 1, wherein the one surface and the other surface are determined based on the size of the image area.

5. The apparatus according to claim 1, wherein the one surface is a first surface and the other surface is a second surface.

6. The apparatus according to claim 1, wherein if the image density on one surface of the recording medium is higher than the image density on the other surface, the controller corrects the image density at the location on the one surface to a value not higher than the image density at the location on the other surface.

7. The apparatus according to claim 1, wherein if the image density on one surface of the recording medium is higher than the image density on the other surface and the penetration depth of the aqueous ink adhered to the other surface into the recording medium is not more than half the thickness of the recording medium, the controller corrects the image density at the location on the one surface to a value equal to the image density at the location on the other surface.

8. The apparatus according to claim 1, wherein the apparatus has a plurality of inkjet heads as the inkjet head and the apparatus performs color printing.

9. The apparatus according to claim 8, wherein the apparatus has only one inkjet head for black as the inkjet head.

10. The apparatus according to claim 9, wherein if both-side printing is performed, the controller gives an instruction to allow the recording medium to pass through in the reversing mechanism and to move to a position facing the inkjet head a plurality of times.

11. The apparatus according to claim 9, wherein the reversing mechanism is located on the upper side of the inkjet head and in the direction orthogonal to the upper side.

12. The apparatus according to claim 8, wherein the apparatus has a plurality of inkjet heads as the inkjet head and printing on one surface and printing on the other surface are performed using different inkjet heads.

13. The apparatus according to claim 12, wherein the recording medium reversing mechanism has a U shape.

14. An inkjet image forming method performed by an inkjet image forming apparatus having a both-side recording function in which after an image is formed on the front surface of a recording medium by ejecting an aqueous ink from an inkjet head, the recording medium is reversed, and an image is formed on the rear surface of the recording medium, comprising:
detecting the location information of an overlapping region of images to be recorded on the front surface and the rear surface if a both-side recording mode is designated;
determining the density of images to be recorded at the location on the front surface and the rear surface based on the detected location information;
reducing the image density at the location on one surface if the image density on the one surface is higher than the image density on the other surface; and
ejecting the ink from the inkjet head.

15. The method according to claim 14, wherein the one surface and the other surface are determined based on the size of the image area.

16. The method according to claim 14, wherein the one surface is a first surface and the other surface is a second surface.

17. The method according to claim 14, wherein if the image density on one surface of the recording medium is higher than the image density on the other surface, the image density at the location on the one surface is corrected to a value not higher than the image density at the location on the other surface.

18. The method according to claim 14, wherein if the image density on one surface of the recording medium is higher than the image density on the other surface and the penetration depth of the aqueous ink adhered to the other surface into the recording medium is not more than half the thickness of the recording medium, the image density at the location on the one surface is corrected to a value equal to the image density at the location on the other surface.

19. The method according to claim 14, wherein only the surface on which printing is first performed using the inkjet head is dried.
